(19) United States
(12) Patent Application Publication
(10) Pub. No.: US 2021/0155250 A1
(43) Pub. Date: May 27, 2021

(54) HUMAN-COMPUTER INTERACTION METHOD, VEHICLE-MOUNTED DEVICE AND READABLE STORAGE MEDIUM

(71) Applicant: Mobile Drive Technology Co.,Ltd., New Taipei (TW)

(72) Inventors: TING-HAO CHUNG, New Taipei (TW); YU-CHING WANG, New Taipei (TW); TZU-KUEI HUANG, New Taipei (TW); CHUN-YI WANG, New Taipei (TW); NAI-SHENG SYU, New Taipei (TW); CHUN-HSIANG HUANG, New Taipei (TW)

(21) Appl. No.: 16/934,808

(22) Filed: Jul. 21, 2020

(30) Foreign Application Priority Data
Nov. 22, 2019 (CN) 201911158229.7

(51) Int. Cl. B60W 40/08; B60W 30/00

(52) U.S. Cl. CPC B60W 40/08; B60W 30/00; B60W 2420/42; B60W 2040/0872; B60W 2540/223; B60W 2040/0827; B60W 2540/22; B60W 2540/26; B60W 2540/229; B60W 2040/0881

(57) ABSTRACT

A human-computer interaction method applied to a vehicle-mounted device is provided. The method includes obtaining video data of a scene inside a vehicle which is captured by a camera in real time. An action of a passenger in each of a plurality of seating positions in the vehicle is detected from the video data. Once a specified action is detected, a corresponding control operation is executed based on the specified action and the seating position of the passenger who performs the specified action.

### FIELD

The present disclosure relates to vehicle control technologies, in particular to a human-computer interaction method, a vehicle-mounted device, and a readable storage medium.

### BACKGROUND

With the popularity of vehicles, people use vehicles more and more frequently in their lives. However, no vehicle currently allows effective and convenient interactions with the passengers in a vehicle, to enable the passengers have a good experience during vehicle travel.

### BRIEF DESCRIPTION OF THE DRAWINGS

FIG. 1 shows a flowchart of one embodiment of a human-computer interaction method of the present disclosure.

FIG. 2 shows a schematic block diagram of one embodiment of modules of a human-computer interaction system of the present disclosure.

FIG. 3 shows a schematic block diagram of one embodiment of a vehicle-mounted device in a vehicle of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

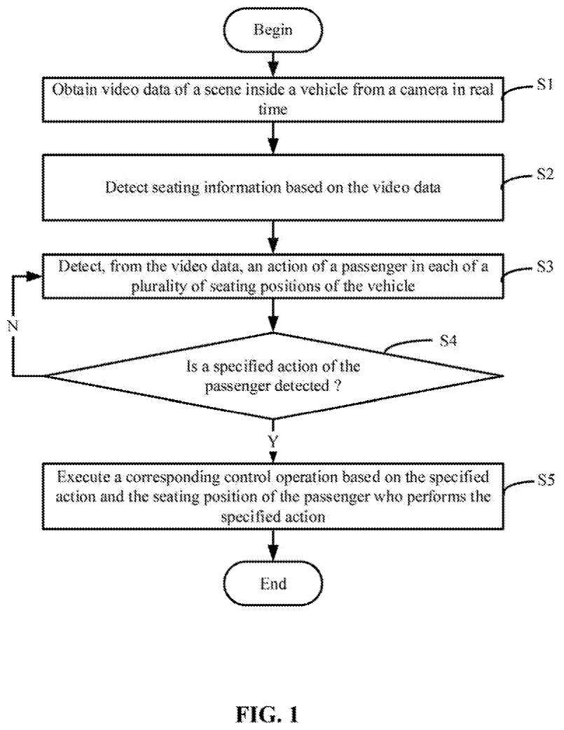

FIG. 1 shows a flowchart of one embodiment of a human-computer interaction method of the present disclosure.

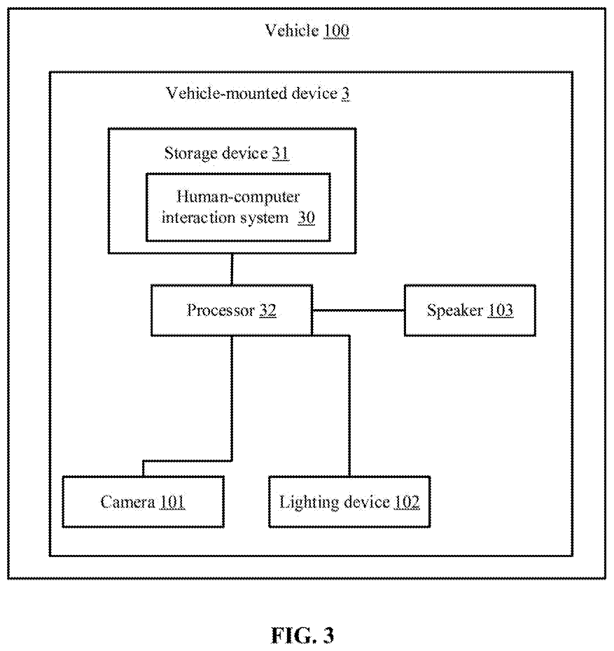

In one embodiment, the human-computer interaction method can be applied to a vehicle-mounted device (e.g., a vehicle-mounted device 3 in FIG. 3). For a vehicle-mounted device that needs to perform a human-computer interaction, the function for the human-computer interaction provided by the method of the present disclosure can be directly integrated on the vehicle-mounted device, or run on the vehicle-mounted device in the form of a software development kit (SDK).

At block S1, a vehicle-mounted device obtains video data of a scene inside a vehicle (e.g., a vehicle 100 in FIG. 3) from a camera (e.g., a camera 101 in FIG. 3) in real time. The camera captures the scene inside the vehicle in real time.

The vehicle includes a plurality of seating positions. In this embodiment, the plurality of seating positions includes a driving position and one or more non-driving positions. In one embodiment, the driving position can be defined to a seating position of a driver of the vehicle. The non-driving positions may include a co-pilot position, and rear positions behind the driving position and/or the co-pilot position. The rear positions may include a left rear position adjacent to a left behind door, a right rear position adjacent to a right behind door, and a middle rear position between the left rear position and the right rear position.

In this embodiment, the camera can be a wide-angle camera, and capture images of the scene inside the vehicle, such that the images captured by the camera include a passenger in each of the plurality of seating positions.

In this embodiment, the camera can be installed at any position inside the vehicle as long as the camera can capture the images of the passenger in each of the plurality of seating positions. In other words, a position of the camera in the vehicle can be determined by a user.

In other embodiments, each of the plurality of seating positions can be configured with one camera, thereby each of the cameras corresponding to each of the plurality of seating positions can capture images of a corresponding passenger.

At block S2, the vehicle-mounted device detects seating information based on the video data. The seating information includes whether each of the plurality of seating positions is occupied by a passenger.

In one embodiment, the seating information further includes: a face image of a corresponding passenger when one of the plurality of seating positions is occupied by the corresponding passenger.

In one embodiment, the detecting of the seating information based on the video data includes (t1)-(t2):

(t1) Determining whether each of the plurality of seating positions is occupied by a passenger based on the video data;

(t2) If any one of the plurality of seating positions is occupied by a passenger, associating the any one of the plurality of seating positions with a face image of the corresponding passenger. The corresponding passenger is the passenger occupies the any one of the plurality of seating positions.

In one embodiment, the determining of whether each of the plurality of seating positions is occupied by the passenger based on the video data includes (a1)-(a3):

(a1) Taking a picture frame from the video data, and identifying one or more human faces from the picture frame.

Specifically, a face recognition algorithm may be used to identify each of the one or more human faces from the picture frame.

(a2) Determining coordinates of each of the one or more human faces in the picture frame, and associating the each of the one or more human faces with the coordinates.

Specifically, the vehicle-mounted device can first establish a coordinate system based on the picture frame, and then determine the coordinates of each of the one or more human faces in the picture frame based on the coordinate system.

For example, the vehicle-mounted device can establish the coordinate system by setting a lower left corner of the picture frame as the origin of the coordinate system, a lower edge of the picture frame as a horizontal axis of the coordinate system, and a left edge of the picture frame as a vertical axis of the coordinate system.

(a3) Determining whether the each of the plurality of seating positions is occupied by the passenger according to the coordinates corresponding to the each of the one or more human faces.

Specifically, the determining whether each of the plurality of seating positions is occupied by a passenger according to the coordinates corresponding to each of the one or more human faces includes (a31)-(a32):

(a31) Storing an image template, wherein the image template is captured by the camera when none of the plurality of seating positions is occupied; determining an area of the each of the plurality of seating positions in the image template; determining coordinates corresponding to the area of the each of the plurality of seating positions in the image template, thereby the coordinates corresponding to the each of the plurality of seating positions in the image template are obtained.

Specifically, the area of each of the plurality of seating positions in the image template can be determined by identifying a seat corresponding to each of the plurality of seating positions using an image recognition algorithm such as a template matching algorithm.

In addition, the determining of the coordinates corresponding to the area of each of the plurality of seating positions in the image template includes establishing a coordinate system based on the image template. It should be noted that a principle of establishing the coordinate system based on the image template is the same as a principle of establishing the coordinate system based on the picture frame. For example, the vehicle-mounted device can establish the coordinate system based on the image template by setting a lower left corner of the image template as the origin, a lower edge of the image template as a horizontal axis, and a left edge of the image template as a vertical axis.

(a32) Matching the coordinates corresponding to the each of the one or more human faces with the coordinates corresponding to the each of the plurality of seating positions, thereby a result of whether the each of the plurality of seating positions is occupied by a passenger is obtained.

Specifically, when a proportion of the coordinates corresponding to a certain human face to the coordinates corresponding to a certain seating position reaches a preset value (e.g., 90% or 95%), the vehicle-mounted device can determine that the certain seating position is occupied by a passenger. The certain seating position can be any one of the plurality of seating positions, and the certain human face can be any one of the one or more human faces identified from the picture frame.

For example, if a proportion of the coordinates corresponding to a certain human face to the coordinates corresponding to the co-pilot position reaches the preset value (e.g., 90%), the vehicle-mounted device can determine that the co-pilot position is occupied by a passenger.

In one embodiment, when any one of the plurality of seating positions in the vehicle is occupied by a passenger, the vehicle-mounted device can associate the any one of the plurality of seating positions with the corresponding human face.

In one embodiment, the seating information further includes attributes of the corresponding passenger of each of the plurality of seating positions.

In this embodiment, the attributes of the corresponding passenger of each of the plurality of seating positions may include, but are not limited to, an age, a gender, and a preference of the corresponding passenger. The preference includes, but is not limited to, a seating position, a tilt angle of a seat of the seating position, settings of an air conditioner, a volume of a speaker, and a light intensity value of a lighting device.

In this embodiment, the vehicle-mounted device can establish a relationship between the preference, the age, and the gender in advance, so that when the gender and age of the passenger are obtained, the corresponding preference of the passenger can be obtained.

In this embodiment, the vehicle-mounted device can input the human face corresponding to each of the plurality of seating positions to an age recognition model, and obtain the age of the passenger corresponding to each of the plurality of seating positions.

The vehicle-mounted device can input the human face corresponding to each of the plurality of seating positions to a gender recognition model, and obtain the gender of the passenger corresponding to each of the plurality of seating positions.

In this embodiment, the method of the vehicle-mounted device training the age recognition model includes (b1)-(b3):

(b1) Collecting a first number (e.g., 100,000) of pictures containing human faces as training samples, and grouping the training samples into a second number of groups according to an age of the human face included in each of the first number of pictures, each of the second number of groups corresponding to an age range.

(b2) Extracting a facial feature of each picture of a certain group, and obtaining a vector of the facial feature of the each picture; averaging all obtained vectors and obtaining an averaged vector; setting the averaged vector as the vector corresponding to the certain group. The certain group is any one of the second number of groups.

(b3) Calculating a vector corresponding to each of other groups of the second number of groups according to (b2). The other groups refer to the second number of groups except the certain group. The vehicle-mounted device can set the vector corresponding to each of the second number of groups as the age recognition model. Such that when the vehicle-mounted device obtains a picture of a human face, the vehicle-mounted device can obtain a vector corresponding to the obtained picture, and obtains an age range of the human face using the age recognition model according to the vector corresponding to the obtained picture.

In this embodiment, the method of the vehicle-mounted device training the gender recognition model includes (c1)-(c3):

(c1) Collecting a third number (e.g., 300,000) of pictures containing faces as training samples, and dividing the training samples into two groups according to a gender corresponding to each of the third number of pictures. Each of the two groups corresponds to one gender, i.e., one of the two groups corresponds to female, and another of the two groups corresponds to male.

(c2) Extracting a facial feature of each picture in one of the two groups; obtaining a vector of the facial feature of the each picture in the one of the two groups; averaging all of the obtained vectors and obtaining an averaged vector; and setting the averaged vector as the vector corresponding to the one of the two groups. The one of the two groups is any one of the two groups.

(c3) Calculating a vector corresponding to another group of the two groups according to (c2). Such that the vector corresponding to each of the two groups is obtained, and the vehicle-mounted device can set the vector corresponding to each of the two groups as the gender recognition model. Such that when the vehicle-mounted device obtains a picture of a human face, the vehicle-mounted device can obtain a vector corresponding to the obtained picture, and obtains a gender of the human face using the gender recognition model according to the vector corresponding to the obtained picture.

At block S3, the vehicle-mounted device detects an action of the passenger in each of the plurality of seating positions.

In one embodiment, the vehicle-mounted device detects, from the video data, the action of the passenger using a human action recognition algorithm.

In one embodiment, the vehicle-mounted device detects the action of the passenger in each of the plurality of seating positions using an action recognition model.

In one embodiment, the vehicle-mounted device training the action recognition model includes:

(d1) Collecting a fourth number of videos (e.g., 300,000) as a sample set, each video being corresponding to one action, the one action can be any one action of preset actions; grouping the fourth number of videos into a number of groups according to the action corresponding to each video, each of the number of groups corresponds to one of the preset actions.

The preset actions may include, but are not limited to, an action of making a call, an action of looking at a cell phone, an action of dozing off, and other actions.

(d2) Extracting a number of kinds of features from each video in each group; inputting the extracted features into a convolutional neural network; and obtaining the action recognition model by performing an end-to-end training to the convolutional neural network according to the extracted features.

In one embodiment, the number of kinds of features may include, but are not limited to, gray feature, horizontal gradient feature, vertical gradient feature, horizontal optical flow feature and vertical optical flow feature.

At block S4, the vehicle-mounted device determines whether a specified action of the passenger is detected. When the specified action of the passenger is detected, the process goes to block S5. When the specified action is not detected, the process goes to block S3, the vehicle-mounted device continues to detect the action of each passenger in each of the plurality of seating positions.

In this embodiment, the specified action can be any one of the preset actions. As mentioned above, the preset actions may include, but are not limited to, the action of making a call, the action of looking at a mobile phone, the action of dozing off, and other actions.

At block S5, the vehicle-mounted device executes a corresponding control operation based on the specified action and the seating position of the passenger who performs the specified action.

In one embodiment, the executing the corresponding control operation based on the specified action and the seating position of the passenger who performs the specified action includes: performing different control operations in response to the specified action when the specified action corresponds to different seating positions.

In one embodiment, the executing the corresponding control operation based on the specified action and the seating position of the passenger who performs the specified action includes:

(f1) When the specified action is the action of making a call, and the seating position of the passenger who performs the action of making the call is not the driving position such as the seating position is the rear position or the co-pilot position, turning down a volume of a specified audio device corresponding to the seating position. For example, it is assumed that the passenger who performs the action of making the call is one of the passengers seating in a rear position, the volume of the audio device corresponding to the rear position can be turned down.

(f2) When the specified action is the action of looking at a cell phone, and the seating position of the passenger who performs the specified action is not the driving position such as the seating position is the rear position, turning on a lighting device (e.g., a lighting device in FIG. 3) corresponding to the seating position, the lighting device is used for lighting for the passenger in the seating position.

(f3) When the specified action is the action of dozing off, and the seating position of the passenger who performs the specified action is not the driving position such as the seating position is the co-pilot position or the rear position, turning off a lighting device corresponding to the seating position. The lighting device is used for lighting for the passenger in the seating position.

(f4) When the specified action is the action of making a call, the specified action is the action of looking at the cell phone, or the specified action is the action of dozing off, and the seating position of the passenger who performs the specified action is the driving position, outputting a warning. For example, the vehicle-mounted device may warn a driver of the vehicle by playing a warning sound using a speaker (e.g., a speaker 103 in FIG. 3).

In other embodiments, the vehicle-mounted device may execute the corresponding control operation based on the seating position and the attributes of the passenger who performs the specified action.

For example, when the seating position of the passenger is the rear position adjacent to the left behind door of the vehicle, and the age of the passenger belongs to an age range of children (e.g., 0-14 years old), the vehicle-mounted device can lock the left behind door.

In other embodiments, the vehicle-mounted device may execute the corresponding control operation based on the specified action, the seating position and the attributes of the passenger who performs the specified action.

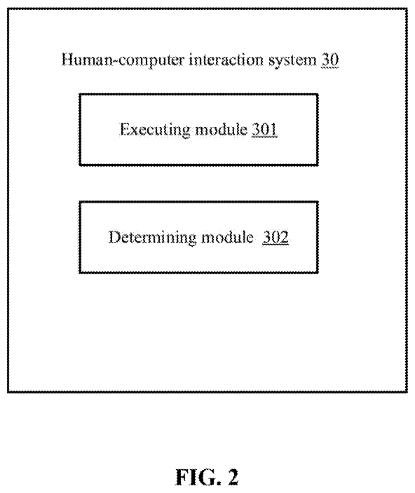

FIG. 2 shows a schematic block diagram of an embodiment of modules of a human-computer interaction system 30 of the present disclosure.

In some embodiments, the human-computer interaction system 30 runs in a vehicle-mounted device. The human-computer interaction system 30 may include a plurality of modules. The plurality of modules can comprise computerized instructions in a form of one or more computer-readable programs that can be stored in a non-transitory computer-readable medium (e.g., a storage device 31 of the vehicle-mounted device 3 in FIG. 3), and executed by at least one processor (e.g., a processor 32 in FIG. 3) of the vehicle-mounted device to implement human-computer interaction function (described in detail in FIG. 1).

In at least one embodiment, the human-computer interaction system 30 may include a plurality of modules. The plurality of modules may include, but is not limited to, an executing module 301 and a determining module 302. The modules 301-302 can comprise computerized instructions in the form of one or more computer-readable programs that can be stored in the non-transitory computer-readable medium (e.g., the storage device 31 of the vehicle-mounted device 3), and executed by the at least one processor (e.g., a processor 32 in FIG. 3) of the vehicle-mounted device to implement human-computer interaction function (e.g., described in detail in FIG. 1).

The executing module 301 obtains video data of a scene inside a vehicle (e.g., a vehicle 100 in FIG. 3) from a camera (e.g., a camera 101 in FIG. 3) in real time. The camera captures the scene inside the vehicle in real time.

The vehicle includes a plurality of seating positions. In this embodiment, the plurality of seating positions includes a driving position and one or more non-driving positions. In one embodiment, the driving position can be defined to a seating position of a driver of the vehicle. The non-driving positions may include a co-pilot position, and rear positions behind the driving position and/or the co-pilot position. The rear positions may include a left rear position adjacent to a left behind door, a right rear position adjacent to a right behind door, and a middle rear position between the left rear position and the right rear position.

In this embodiment, the camera can be a wide-angle camera, and capture images of the scene inside the vehicle, such that the images captured by the camera include a passenger in each of the plurality of seating positions.

In this embodiment, the camera can be installed at any position inside the vehicle as long as the camera can capture the images of the passenger in each of the plurality of seating positions. In other words, a position of the camera in the vehicle can be determined by a user.

In other embodiments, each of the plurality of seating positions can be configured with one camera, thereby each of the cameras corresponding to each of the plurality of seating positions can capture images of a corresponding passenger.

The executing module 301 detects seating information based on the video data. The seating information includes whether each of the plurality of seating positions is occupied by a passenger.

In one embodiment, the seating information further includes: a face image of a corresponding passenger when one of the plurality of seating positions is occupied by the corresponding passenger.

In one embodiment, the detecting of the seating information based on the video data includes (t1)-(t2):

(t1) Determining whether each of the plurality of seating positions is occupied by a passenger based on the video data;

(t2) If any one of the plurality of seating positions is occupied by a passenger, associating the any one of the plurality of seating positions with a face image of the corresponding passenger. The corresponding passenger is the passenger occupies the any one of the plurality of seating positions.

In one embodiment, the determining of whether each of the plurality of seating positions is occupied by the passenger based on the video data includes (a1)-(a3):

(a1) Taking a picture frame from the video data, and identifying one or more human faces from the picture frame.

Specifically, a face recognition algorithm may be used to identify each of the one or more human faces from the picture frame.

(a2) Determining coordinates of each of the one or more human faces in the picture frame, and associating the each of the one or more human faces with the coordinates.

Specifically, the executing module 301 can first establish a coordinate system based on the picture frame, and then determine the coordinates of each of the one or more human faces in the picture frame based on the coordinate system.

For example, the executing module 301 can establish the coordinate system by setting a lower left corner of the picture frame as the origin of the coordinate system, a lower edge of the picture frame as a horizontal axis of the coordinate system, and a left edge of the picture frame as a vertical axis of the coordinate system.

(a3) Determining whether the each of the plurality of seating positions is occupied by the passenger according to the coordinates corresponding to the each of the one or more human faces.

Specifically, the determining whether each of the plurality of seating positions is occupied by a passenger according to the coordinates corresponding to each of the one or more human faces includes (a31)-(a32):

(a31) Storing an image template, wherein the image template is captured by the camera when none of the plurality of seating positions is occupied; determining an area of the each of the plurality of seating positions in the image template; determining coordinates corresponding to the area of the each of the plurality of seating positions in the image template, thereby the coordinates corresponding to the each of the plurality of seating positions in the image template are obtained.

Specifically, the area of each of the plurality of seating positions in the image template can be determined by identifying a seat corresponding to each of the plurality of seating positions using an image recognition algorithm such as a template matching algorithm.

In addition, the determining of the coordinates corresponding to the area of each of the plurality of seating positions in the image template includes establishing a coordinate system based on the image template. It should be noted that a principle of establishing the coordinate system based on the image template is the same as a principle of establishing the coordinate system based on the picture frame. For example, the executing module 301 can establish the coordinate system based on the image template by setting a lower left corner of the image template as the origin, a lower edge of the image template as a horizontal axis, and a left edge of the image template as a vertical axis.

(a32) Matching the coordinates corresponding to the each of the one or more human faces with the coordinates corresponding to the each of the plurality of seating positions, thereby a result of whether the each of the plurality of seating positions is occupied by a passenger is obtained.

Specifically, when a proportion of the coordinates corresponding to a certain human face to the coordinates corresponding to a certain seating position reaches a preset value (e.g., 90% or 95%), the executing module 301 can determine that the certain seating position is occupied by a passenger. The certain seating position can be any one of the plurality of seating positions, and the certain human face can be any one of the one or more human faces identified from the picture frame.

For example, if a proportion of the coordinates corresponding to a certain human face to the coordinates corresponding to the co-pilot position reaches the preset value (e.g., 90%), the executing module 301 can determine that the co-pilot position is occupied by a passenger.

In one embodiment, when any one of the plurality of seating positions in the vehicle is occupied by a passenger, the executing module 301 can associate the any one of the plurality of seating positions with the corresponding human face.

In one embodiment, the seating information further includes attributes of the corresponding passenger of each of the plurality of seating positions.

In this embodiment, the attributes of the corresponding passenger of each of the plurality of seating positions may include, but are not limited to, an age, a gender, and a preference of the corresponding passenger. The preference includes, but is not limited to, a seating position, a tilt angle of a seat of the seating position, settings of an air conditioner, a volume of a speaker, and a light intensity value of a lighting device.

In this embodiment, the executing module 301 can establish a relationship between the preference, the age, and the gender in advance, so that when the gender and age of the passenger are obtained, the corresponding preference of the passenger can be obtained.

In this embodiment, the executing module 301 can input the human face corresponding to each of the plurality of seating positions to an age recognition model, and obtain the age of the passenger corresponding to each of the plurality of seating positions.

The executing module 301 can input the human face corresponding to each of the plurality of seating positions to a gender recognition model, and obtain the gender of the passenger corresponding to each of the plurality of seating positions.

In this embodiment, the method of the executing module 301 training the age recognition model includes (b1)-(b3):

(b1) Collecting a first number (e.g., 100,000) of pictures containing human faces as training samples, and grouping the training samples into a second number of groups according to an age of the human face included in each of the first number of pictures, each of the second number of groups corresponding to an age range.

(b2) Extracting a facial feature of each picture of a certain group, and obtaining a vector of the facial feature of the each picture; averaging all obtained vectors and obtaining an averaged vector; setting the averaged vector as the vector corresponding to the certain group. The certain group is any one of the second number of groups.

(b3) Calculating a vector corresponding to each of other groups of the second number of groups according to (b2). The other groups refer to the second number of groups except the certain group. The executing module 301 can set the vector corresponding to each of the second number of groups as the age recognition model. Such that when the executing module 301 obtains a picture of a human face, the executing module 301 can obtain a vector corresponding to the obtained picture, and obtains an age range of the human face using the age recognition model according to the vector corresponding to the obtained picture.

In this embodiment, the method of the executing module 301 training the gender recognition model includes (c1)-(c3):

(c1) Collecting a third number (e.g., 300,000) of pictures containing faces as training samples, and dividing the training samples into two groups according to a gender corresponding to each of the third number of pictures. Each of the two groups corresponds to one gender, i.e., one of the two groups corresponds to female, and another of the two groups corresponds to male.

(c2) Extracting a facial feature of each picture in one of the two groups; obtaining a vector of the facial feature of the each picture in the one of the two groups; averaging all of the obtained vectors and obtaining an averaged vector; and setting the averaged vector as the vector corresponding to the one of the two groups. The one of the two groups is any one of the two groups.

(c3) Calculating a vector corresponding to another group of the two groups according to (c2). Such that the vector corresponding to each of the two groups is obtained, and the executing module 301 can set the vector corresponding to each of the two groups as the gender recognition model. Such that when the executing module 301 obtains a picture of a human face, the executing module 301 can obtain a vector corresponding to the obtained picture, and obtains a gender of the human face using the gender recognition model according to the vector corresponding to the obtained picture.

The executing module 301 detects an action of the passenger in each of the plurality of seating positions. In one embodiment, the executing module 301 detects, from the video data, the action of the passenger using a human action recognition algorithm.

In one embodiment, the executing module 301 detects the action of the passenger in each of the plurality of seating positions using an action recognition model.

In one embodiment, the executing module 301 training the action recognition model includes:

(d1) Collecting a fourth number of videos (e.g., 300,000) as a sample set, each video being corresponding to one action, the one action can be any one action of preset actions; grouping the fourth number of videos into a number of groups according to the action corresponding to each video, each of the number of groups corresponds to one of the preset actions.

The preset actions may include, but are not limited to, an action of making a call, an action of looking at a cell phone, an action of dozing off, and other actions.

(d2) Extracting a number of kinds of features from each video in each group; inputting the extracted features into a convolutional neural network; and obtaining the action recognition model by performing an end-to-end training to the convolutional neural network according to the extracted features.

In one embodiment, the number of kinds of features may include, but are not limited to, gray feature, horizontal gradient feature, vertical gradient feature, horizontal optical flow feature and vertical optical flow feature.

The determining module 302 determines whether a specified action of the passenger is detected. When the specified action is not detected, the executing module 301 continues to detect the action of each passenger in each of the plurality of seating positions.

In this embodiment, the specified action can be any one of the preset actions. As mentioned above, the preset actions may include, but are not limited to, the action of making a call, the action of looking at a mobile phone, the action of dozing off, and other actions.

When the specified action of the passenger is detected, the executing module 301 executes a corresponding control operation based on the specified action and the seating position of the passenger who performs the specified action.

In one embodiment, the executing the corresponding control operation based on the specified action and the seating position of the passenger who performs the specified action includes: performing different control operations in response to the specified action when the specified action corresponds to different seating positions.

In one embodiment, the executing the corresponding control operation based on the specified action and the seating position of the passenger who performs the specified action includes:

(f1) When the specified action is the action of making a call, and the seating position of the passenger who performs the action of making the call is not the driving position such as the seating position is the rear position or the co-pilot position, turning down a volume of a specified audio device corresponding to the seating position. For example, it is assumed that the passenger who performs the action of making the call is one of the passengers seating in a rear position, the volume of the audio device corresponding to the rear position can be turned down.

(f2) When the specified action is the action of looking at a cell phone, and the seating position of the passenger who performs the specified action is not the driving position such as the seating position is the rear position, turning on a lighting device corresponding to the seating position, the lighting device is used for lighting for the passenger in the seating position.

(f3) When the specified action is the action of dozing off, and the seating position of the passenger who performs the specified action is not the driving position such as the seating position is the co-pilot position or the rear position, turning off a lighting device corresponding to the seating position. The lighting device is used for lighting for the passenger in the seating position.

(f4) When the specified action is the action of making a call, the specified action is the action of looking at the cell phone, or the specified action is the action of dozing off, and the seating position of the passenger who performs the specified action is the driving position, outputting a warning. For example, the executing module 301 may warn a driver of the vehicle by playing a warning sound using a speaker.

In other embodiments, the executing module 301 may execute the corresponding control operation based on the seating position and the attributes of the passenger who performs the specified action.

For example, when the seating position of the passenger is the rear position adjacent to the left behind door of the vehicle, and the age of the passenger belongs to an age range of children (e.g., 0-14 years old), the executing module 301 can lock the left behind door.

In other embodiments, the executing module 301 may execute the corresponding control operation based on the specified action, the seating position and the attributes of the passenger who performs the specified action.

FIG. 3 shows a schematic block diagram of one embodiment of a vehicle-mounted device 3 in a vehicle 100. The vehicle-mounted device 3 is installed in the vehicle 100. The vehicle-mounted device 3 is essentially a vehicle-mounted computer. In an embodiment, the vehicle-mounted device 3 may include, but is not limited to, at least one camera 101, one or more lighting device 102, one or more speaker 103, and other elements. The human-computer interaction system 30 is used to execute corresponding control operation according to the action of the passenger in the vehicle 100 and the seating position of the passenger (details will be described later).

In this embodiment, the vehicle 100 includes a plurality of seating positions. In this embodiment, the plurality of seating positions includes a driving position, a co-pilot position, and rear positions behind the driving position and/or the co-pilot position. The rear positions may include a left rear position adjacent to a left behind door of the vehicle 100, a right rear position adjacent to a right behind door of the vehicle 100, and a middle rear position between the left rear position and the right rear position.

In this embodiment, the camera 101 can be a wide-angle camera, and capture images of the scene inside the vehicle 100, such that the images captured by the camera include a passenger in each of the plurality of seating positions.

In this embodiment, the camera 101 can be installed at any position inside the vehicle 100 as long as the camera 101 can capture the images of the passenger in each of the plurality of seating positions. In other words, a position of the camera 101 in the vehicle 100 can be determined by a user.

In other embodiments, each of the plurality of seating positions can be configured with one camera 101, thereby each of the cameras 101 corresponding to each of the plurality of seating positions can capture images of a corresponding passenger in real time.

In this embodiment, the one or more lighting devices 102 are installed inside the vehicle 100. The one or more speakers 103 may be used to reproduce audio data.

In this embodiment, the vehicle-mounted device 3 may further include a storage device 31 and at least one processor 32 electrically connected to each other.

It should be understood by those skilled in the art that the structure of the vehicle-mounted device 3 shown in FIG. 3 does not constitute a limitation of the embodiment of the present disclosure. The vehicle-mounted device 3 may further include other hardware or software, or the vehicle-mounted device 3 may have different component arrangements. For example, the vehicle-mounted device 3 can further including a display device.

In at least one embodiment, the vehicle-mounted device 3 may include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the vehicle-mounted device 3 is merely an example, and other existing or future electronic products may be included in the scope of the present disclosure, and are included in the reference.

In some embodiments, the storage device 31 can be used to store program codes of computer readable programs and various data, such as the human-computer interaction system 30 installed in the vehicle-mounted device 3, and automatically access to the programs or data with high speed during running of the vehicle-mounted device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the vehicle-mounted device 3 that can be used to carry or store data.

In some embodiments, the at least one processor 32 may be composed of an integrated circuit, for example, may be composed of a single packaged integrated circuit, or multiple integrated circuits of same function or different functions. The at least one processor 32 can include one or more central processing units (CPU), a microprocessor, a digital processing chip, a graphics processor, and various control chips. The at least one processor 32 is a control unit of the vehicle-mounted device 3, which connects various components of the vehicle-mounted device 3 using various interfaces and lines. By running or executing a computer program or modules stored in the storage device 31, and by invoking the data stored in the storage device 31, the at least one processor 32 can perform various functions of the vehicle-mounted device 3 and process data of the vehicle-mounted device 3. For example, the function of performing the human-computer interaction.

Although not shown, the vehicle-mounted device 3 may further include a power supply (such as a battery) for powering various components. Preferably, the power supply may be logically connected to the at least one processor 32 through a power management device, thereby, the power management device manages functions such as charging, discharging, and power management. The power supply may include one or more a DC or AC power source, a recharging device, a power failure detection circuit, a power converter or inverter, a power status indicator, and the like. The vehicle-mounted device 3 may further include various sensors, such as a BLUETOOTH module, a Wi-Fi module, and the like, and details are not described herein.

In at least one embodiment, as shown in FIG. 2, the at least one processor 32 can execute various types of applications (such as the human-computer interaction system 30) installed in the vehicle-mounted device 3, program codes, and the like. For example, the at least one processor 32 can execute the modules 301-302 of the human-computer interaction system 30.

In at least one embodiment, the storage device 31 stores program codes. The at least one processor 32 can invoke the program codes stored in the storage device to perform functions. For example, the modules described in FIG. 3 are program codes stored in the storage device 31 and executed by the at least one processor 32, to implement the functions of the various modules for the purpose of realizing human-computer interaction as described in FIG. 1.

In at least one embodiment, the storage device 31 stores one or more instructions (i.e., at least one instruction) that are executed by the at least one processor 32 to achieve the purpose of realizing human-computer interaction as described in FIG. 1.

In at least one embodiment, the at least one processor 32 can execute the at least one instruction stored in the storage device 31 to perform the operations of as shown in FIG. 1.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A human-computer interaction method applied to a vehicle-mounted device, the human-computer interaction method comprising:
obtaining video data of a scene inside a vehicle, from a camera in real time, wherein the vehicle comprises a plurality of seating positions;
detecting, from the video data, an action of a passenger in each of the plurality of seating positions in the vehicle; and
executing a corresponding control operation based on a specified action and the seating position of the passenger who performs the specified action, when the detected action is the specified action.

2. The human-computer interaction method according to claim 1, further comprising:
determining whether the each of the plurality of seating positions is occupied by the passenger based on the video data;
associating any one of the plurality of seating positions with a face image of a corresponding passenger, when the each of the plurality of seating positions is occupied by the passenger.

3. The human-computer interaction method according to claim 2, wherein the determining whether the each of the plurality of seating positions is occupied by the passenger based on the video data comprises:
taking a picture frame from the video data, and identifying one or more human faces from the picture frame;
determining coordinates of each of the one or more human faces in the picture frame, and associating the each of the one or more human faces with the coordinates; and
determining whether the each of the plurality of seating positions is occupied by the passenger according to the coordinates corresponding to the each of the one or more human faces.

4. The human-computer interaction method according to claim 3, wherein the determining whether the each of the plurality of seating positions is occupied by the passenger according to the coordinates corresponding to the each of the one or more human faces comprises:
storing an image template, wherein the image template is captured by the camera when none of the plurality of seating positions is occupied;
determining an area of the each of the plurality of seating positions in the image template;
determining coordinates corresponding to the area of the each of the plurality of seating positions in the image template; and
matching the coordinates corresponding to the each of the one or more human faces with the coordinates corresponding to the each of the plurality of seating positions, wherein when a proportion of the coordinates corresponding to a certain human face to the coordinates corresponding to a certain seating position reaches a preset value, the certain seating position is determined to be occupied by the corresponding passenger, wherein the certain seating position is the any one of the plurality of seating positions, and the certain human face is any one of the one or more human faces identified from the picture frame.

5. The human-computer interaction method according to claim 1, wherein the seating position of the passenger who performs the specified action is one of a driving position and a non-driving position, wherein the driving position is a seating position of a driver of the vehicle.

6. The human-computer interaction method according to claim 1, wherein the executing a corresponding control operation based on a specified action and the seating position of the passenger who performs the specified action comprises:
performing different control operations in response to the specified action when the specified action corresponds to different seating positions.

7. The human-computer interaction method according to claim 6, wherein the specified action comprises making a call, looking at a cell phone, and dozing off.

8. A vehicle-mounted device comprising:
a storage device;
at least one processor; and
the storage device storing one or more programs, which when executed by the at least one processor, cause the at least one processor to:
obtain video data of a scene inside a vehicle, from a camera in real time, wherein the vehicle comprises a plurality of seating positions;
detect, from the video data, an action of a passenger in each of the plurality of seating positions in the vehicle; and
execute a corresponding control operation based on a specified action and the seating position of the passenger who performs the specified action, when the detected action is the specified action.

9. The vehicle-mounted device according to claim 8, wherein the at least one processor is further caused to:
determine whether the each of the plurality of seating positions is occupied by the passenger based on the video data;
associate any one of the plurality of seating positions with a face image of a corresponding passenger, when the each of the plurality of seating positions is occupied by the passenger.

10. The vehicle-mounted device according to claim 9, wherein the determining whether the each of the plurality of seating positions is occupied by the passenger based on the video data comprises:
taking a picture frame from the video data, and identifying one or more human faces from the picture frame;
determining coordinates of each of the one or more human faces in the picture frame, and associating the of the one or more human faces with the coordinates; and
determining whether the each of the plurality of seating positions is occupied by the passenger according to the coordinates corresponding to the each of the one or more human faces.

11. The vehicle-mounted device according to claim 10, wherein the determining whether the each of the plurality of seating positions is occupied by the passenger according to the coordinates corresponding to the each of the one or more human faces comprises:
storing an image template, wherein the image template is captured by the camera when none of the plurality of seating positions is occupied;
determining an area of the each of the plurality of seating positions in the image template;
determining coordinates corresponding to the area of the each of the plurality of seating positions in the image template; and
matching the coordinates corresponding to the each of the one or more human faces with the coordinates corresponding to the each of the plurality of seating positions, wherein when a proportion of the coordinates corresponding to a certain human face to the coordinates corresponding to a certain seating position reaches a preset value, the certain seating position is determined to be occupied by the corresponding passenger, wherein the certain seating position is the any one of the plurality of seating positions, and the certain human face is any one of the one or more human faces identified from the picture frame.

12. The vehicle-mounted device according to claim 8, wherein the seating position of the passenger who performs the specified action is one of a driving position and a non-driving position, wherein the driving position is a seating position of a driver of the vehicle.

13. The vehicle-mounted device according to claim 8, wherein the executing a corresponding control operation based on a specified action and the seating position of the passenger who performs the specified action comprises:
performing different control operations in response to the specified action when the specified action corresponds to different seating positions.

14. The vehicle-mounted device according to claim 15, wherein the specified action comprises making a call, looking at a cell phone, and dozing off.

15. A non-transitory storage medium having instructions stored thereon, when the instructions are executed by a processor of a vehicle-mounted device, the processor is configured to perform a human-computer interaction method, wherein the method comprises:
obtaining video data of a scene inside a vehicle, from a camera in real time, wherein the vehicle comprises a plurality of seating positions;
detecting, from the video data, an action of a passenger in each of the plurality of seating positions in the vehicle; and
executing a corresponding control operation based on a specified action and the seating position of the passenger who performs the specified action, when the detected action is the specified action.

16. The non-transitory storage medium according to claim 15, wherein the method further comprises:
determining whether the each of the plurality of seating positions is occupied by the passenger based on the video data;
associating any one of the plurality of seating positions with a face image of a corresponding passenger, when the each of the plurality of seating positions is occupied by the passenger.

17. The non-transitory storage medium according to claim 16, wherein the determining whether the each of the plurality of seating positions is occupied by the passenger based on the video data comprises:
taking a picture frame from the video data, and identifying one or more human faces from the picture frame;
determining coordinates of each of the one or more human faces in the picture frame, and associating the each of the one or more human faces with the coordinates; and
determining whether the each of the plurality of seating positions is occupied by the passenger according to the coordinates corresponding to the each of the one or more human faces.

18. The non-transitory storage medium according to claim 17, wherein the determining whether the each of the plurality of seating positions is occupied by the passenger according to the coordinates corresponding to the each of the one or more human faces comprises:
storing an image template, wherein the image template is captured by the camera when none of the plurality of seating positions is occupied;
determining an area of the each of the plurality of seating positions in the image template;
determining coordinates corresponding to the area of the each of the plurality of seating positions in the image template; and
matching the coordinates corresponding to the each of the one or more human faces with the coordinates corresponding to the each of the plurality of seating positions, wherein when a proportion of the coordinates corresponding to a certain human face to the coordinates corresponding to a certain seating position reaches a preset value, the certain seating position is determined to be occupied by the corresponding passenger, wherein the certain seating position is the any one of the plurality of seating positions, and the certain human face is any one of the one or more human faces identified from the picture frame.

19. The non-transitory storage medium according to claim 15, wherein the seating position of the passenger who performs the specified action is one of a driving position and a non-driving position, wherein the driving position is a seating position of a driver of the vehicle.

20. The non-transitory storage medium according to claim 15, wherein the executing a corresponding control operation based on a specified action and the seating position of the passenger who performs the specified action comprises:
performing different control operations in response to the specified action when the specified action corresponds to different seating positions.
